(19) United States
(12) Patent Application Publication
(10) Pub. No.: US 2022/0198933 A1
(43) Pub. Date: Jun. 23, 2022

(54) SYSTEMS AND METHODS FOR COMPENSATION BETWEEN PARTICIPANTS IN COOPERATIVE DRIVING

(71) Applicants: Robert John Schellin, Stoughton, WI (US); Keith Joseph Thompson, Fitchburg, WI (US)

(72) Inventors: Robert John Schellin, Stoughton, WI (US); Keith Joseph Thompson, Fitchburg, WI (US)

(21) Appl. No.: 17/128,063

(22) Filed: Dec. 19, 2020

(51) Int. Cl. G08G 1/00; G06Q 20/06; G06Q 30/02; G06Q 20/08

(52) U.S. Cl. CPC G08G 1/22; G06Q 20/0855; G06Q 30/0208; G06Q 20/0655

(57) ABSTRACT

This invention relates to systems and methods that provide compensation for participants in a cooperative driving or autonomous driving platoon based on their role within said platoon. Certain roles in these types of platoons provide a natural benefit. Other roles in the same platoon provide either less of a benefit, zero benefit or a burden. It is unlikely that a participating vehicle would willingly choose a role with a lesser benefit or burden; thereby significantly reducing the probability that a platoon could form. The system and methods within this invention overcome that economic disincentive; thereby removing an obstacle to cooperative driving or autonomous platoons.

### BACKGROUND

Self-driving vehicles combine a variety of sensors such as radar, lidar, sonar, GPS, odometry and inertial measurement units as well as others to perceive their surroundings. Advanced control systems interpret this sensory information to identify appropriate navigation paths, as well as obstacles and relevant signage. The result is a vehicle that can navigate and maneuver itself with little to no human interaction. Cooperative driving vehicles form a subset of self-driving vehicles that do not perform all of their functions independently or self-sufficiently but depend on communication or cooperation with additional entities or vehicles. Connecting multiple nearby vehicles in a conformal group led by a lead vehicle, for example for long-distance trucking, is one example of a growing area of cooperative driving. This conformal group is sometimes referred to as a platoon.

In this document, platoon broadly refers to any set or subset of cooperatively driven vehicles where two or more vehicles are formed together in a driving pattern for at least some amount of time. For example, platoon could be interchanged with convoy. Vehicle refers to the truck, car, bus or other machine that could participate in a platoon. Additionally, the term vehicle can include the driver of the vehicle; whether that driver is a person, a computer, an algorithm or some other entity that plays a role in operating the vehicle. The vehicle that bears, or whose driver bears, the primary role of leading the platoon may often-times be referred to as the lead vehicle. A vehicles that participates or that could participate in the platoon outside of a lead vehicle role may be referred to as follower or participant or other similarly phrased term for a secondary vehicle role in the platoon. Compensation generally refers to an individual, organization or entity receiving some type of value-based payment in return for providing some service, bearing some burden or other general contribution. In this document, the term is broadened to include not only the receipt of some type of value or payment but it could also refer to the act of making such payment. In particular, compensation mechanism implies multiple entities, one which receives and the other which contributes; e.g. a payee and a payer.

There are many advantages of two or more vehicles forming together into a cooperatively-driven platoon. The lead vehicle can actively navigate, either autonomously or through human control, while the follower vehicles navigate by automatically or semi-automatically following the direction of the lead vehicle. This removes some or all of the burden of navigation from the follower vehicles. This also removes some or all of the burden of driving from participant vehicles within the platoon. It has also been demonstrated that when two vehicles travel in very close proximity to each other the drag on the second vehicle is dramatically reduced. This improves the fuel economy of the second, or follower, vehicle while not necessarily negatively impacting the fuel economy of the lead vehicle. The lead vehicle may also experience some improvement in fuel economy; although it has generally been demonstrated that when this improvement in fuel economy occurs the benefit is less than that of the follower vehicles. This follower vehicle is therefore economically advantaged by closely following a lead vehicle. Stringing together a number of follower vehicles behind one main lead vehicle creates a consistent reduction in drag along this vehicle platoon; thereby creating a fuel economy advantage for the follower vehicles. This close-driving pattern can technically be achieved through strictly manual, human driving. For example, race cars have demonstrated that drafting improves the fuel economy of one race car who follows closely behind another race car. However, the risk of accident from human management of such close vehicle driving is significant. Additionally, the ability of a human to manually maintain this close driving pattern in a sufficiently consistent fashion to generate the optimal fuel economy savings has yet to be demonstrated. An automated system where the vehicles are actively communicating information regarding speed, acceleration, deceleration, turns and other navigational shifts is generally considered to be more efficient at consistently setting the gap between vehicles in order to optimize fuel economy while minimizing the incremental risks to safety posed by such driving behaviour.

In cooperative driving, the follower vehicle(s) receives the benefits—or the majority of the benefits—from platooning while the lead vehicle bears the burden. This one-sided arrangement reduces or even eliminates the motivation for the lead vehicle to participate. In a centralized system where a common parent organization controls all vehicles in the platoon, a lead vehicle can be designated in order to maximize the overall benefit to that parent organization. For example, long-haul trucking companies could utilize platooning on pre-planned routes to extend daily driving distances, improve safety by reducing the risks from inattentive driving and reduce fuel consumption. In this scenario, the parent trucking company could designate one vehicle to take the lead while designating the other vehicles to take a follower position. The follower vehicles would reap the fuel economy improvement which would, in turn, translate to an overall financial gain by the parent organization. Because benefit and burden are reaped and bourn by the same organization, a one-sided economic arrangement between the individual vehicles does not create an obstacle to participation.

The value to be gained by platooning is not limited to such pre-planned routes managed by a centrally controlled authority. Any time a plurality of vehicles is travelling within reasonable proximity of each other with a common destination and driving pattern over at least a portion of their intended route, a platoon may form if the participants are willing and able to fill the various roles (i.e. at a minimum a leader and a follower) inherent in a platoon. The broad adoption of mobile communication technology further enables these platoons to spontaneously form as individual vehicles are now able to not only identify but also to communicate with potentially willing platoon participants without the need for pre-planned coordination. Utilization of vehicle-to-vehicle communication or vehicle-to-central server schemes, as examples, would allow vehicles to communicate sufficiently to form cooperatively driven platoons on an at-will basis. This democratization of platooning extends the value of cooperative driving beyond a small number of large, commercial entities that are already operating long-haul, convoy services. Now any vehicle with a willingness and capability to join in the benefits of cooperative driving has the opportunity to so participate.

The technical challenges involved with cooperative driving and democratized platoons are being systematically addressed and resolved as is evident in the many related references listed. In addition to these technical challenges, economic challenges to platooning also exist. The benefits of cooperative driving in a platoon are accrued almost entirely, or at least disproportionately, by the follower vehicles with little to no direct benefit naturally accruing to the lead vehicle. It is unlikely that a vehicle would willingly choose the status of lead vehicle when the benefit accrues so disproportionately to choosing the role of follower vehicle. This is particularly acute in a decentralized and democratized system of cooperative driving. As any platoon necessarily requires at least one vehicle willing to select the role of leader, these one-sided economics significantly reduce the incentive, and therefore inhibit, potentially virtually eliminating, the broad-based adoption, of decentralized platoons and the overall benefits to participants of these platoons.

There exists a compelling need for a compensation system where the vehicle(s) participating in certain roles within a platoon, for example as the lead vehicle in a platoon, receive a separate benefit for accepting this role and for foregoing the natural benefits inherent in choosing a different role, for example as a follower vehicle, within the platoon. With a fair and balanced compensation system in place, a lead vehicle would generally and readily exist in probability and frequency to match the corresponding needs of potential participating follower vehicles within a platoon or potential platoon.

### SUMMARY

To achieve the foregoing in accordance with the present invention, Systems and Methods for Compensation Between Participants in Cooperative Driving, are provided. In particular these systems and methods enable: 1) a compensation mechanism where participants in a platoon are provided compensation, separate and outside of the natural compensation inherent for participating in a platoon, for accepting certain roles within that platoon; 2) systems and methods for managing this compensation and (3) optimal ordering of the platoon in alignment with compensation

### DETAILED DESCRIPTION

The present invention overcomes the economic challenges inherent in forming a cooperating driving platoon by providing a system and a method for compensating the owner or driver of at least one vehicle in a platoon. By providing this compensation mechanism at least one participant, or potential participant, in a platoon is incented to forego a position in the platoon with inherent benefits, (e.g. a follower position) in order to instead take a role with fewer or potentially no inherent benefits and possibly with an inherent burden (e.g. the lead vehicle position).

In its most fundamental form: (1) one or more vehicles communicates a willingness to participate in a platoon; (2) an agreement on compensation based on roles in the platoon is reached and (3) the compensation is received from or paid to the appropriate participants.

The method can be streamlined. For example, the initiation can be eliminated by participants pre-selecting their vehicles to participate in a platoon based on certain criteria. Further to this, some participants may even allow their vehicles to always participate in a platoon regardless of criteria. In this embodiment, platooning occurs when a platoon is available and compensation is paid or received based on platoon activity.

In a more robust method, an initiation stage or module indicates the willingness of a vehicle to participate in an existing platoon or in a potential platoon. The relevant information including, but not limited to, the characteristics of the vehicle (size, shape, weight and so forth), its eventual destination, preferred route and preferred driving behaviour (speed and any other preferences) are communicated to potential fellow participants in the platoon. In an active mode existing platoons or individual vehicles are actively queried for opportunities to either join an existing platoon or to form a new platoon. In a more passive mode, the vehicle would not actively seek out platoons or other vehicles with which to platoon but would make itself available to respond to requests from other vehicles who may be interested in forming a platoon. Alternatively, this initiation could be made through a centralized server or from a third party that coordinates platoon formation by matching willing participants.

Once platooning opportunities are identified, the compensation or payment required to fulfill a certain role or vehicle position in a platoon is negotiated between the potential participants with the goal of creating a platoon and a platoon order that is beneficial, and therefore acceptable, to at least two, and ideally more, vehicles. This negotiation may occur through a direct offer, counter-offer approach where at least one participant puts forth an offer to accept a certain position in the platoon and at least one other participant either accepts or puts forth a competing offer. Any participant may put forth multiple offers and counteroffers until a compensation between participants is agreed. Alternatively, a vehicle may identify a role or roles—i.e. leader, follower or position in line—that the vehicle is willing to accept and what compensation, if any, would be required by the vehicle for it to participate in that role are communicated. For example, participants may stipulate a minimum cash payment per mile required for the vehicle to take the leader role. Any participant or participants willing to pay that amount could simply accept and join up with that vehicle in a platoon. Alternately, a participant could put forth the maximum cash pay out offered for the vehicle to take a follower role and allow another vehicle to accept and claim the position of leader vehicle. Additionally, algorithms may be employed that, based on the characteristics of the vehicles in the platoon, based on the conditions at the time of the platoon and based on the compensation requests of these vehicles, the algorithm may order the vehicles in a way that optimizes the overall value generated by the platoon. The system could automatically calculate the most fair compensation to or payment from each vehicle in the platoon based on this optimization scheme. This compensation could be predicated on conditions at the time the platoon is created with an ability to automatically adjust as these conditions evolve. Ultimately, the goal is to bring vehicles into the platoon in a manner that is financially acceptable to each participating vehicle.

At some point, a vehicle will desire to cease participation in a platoon. At this point, the vehicle exits the platoon, the appropriate compensation (receipt of payment from or disbursement of payment to) is calculated and paid based on the agreement as a member of the platoon. The compensation could be paid in local currency, i.e. cash, through a credit system or through other accepted currencies including even cryptocurrencies such as Bitcoin. This compensation may consist of a direct financial payment from the follower vehicle to the lead vehicle. Payment could be transferred between parties through third party software or applications. Compensation could be in the form of a credit system where the follower vehicle pays credits while the lead vehicle receives a credit. These credits could be purchased with cash, traded, gifted or earned. Credits could also be sold for compensation in other forms of currency. Additionally, the credit system could be managed by an independent organization.

The concept of compensation or payment is not necessarily limited to participants within the platoon. An independent third party, for example a non-profit organization or a governmental body, may wish to provide compensation to vehicles who take certain roles within a platoon in order to encourage cooperating driving.

It should be additionally noted that compensation is paid out to and payment are paid by an individual or an entity such as a company, a corporation, partnership or any other entity that could accept compensation or make payment. Anywhere here where a participant, vehicle, member or other entity is referenced as receiving compensation or as making payment or otherwise involved in the compensation system or method, it is intended that the relevant individual or entity capable of receiving a compensation or making a payment or in any other way actually participating within the compensation system and method is the intended recipient or payee.

This compensation system and method could be further augmented by the deployment of mobile devices which when present in one or more of the vehicles could be used to support vehicle-to-vehicle communication or vehicle-to-central server communication and thereby facilitate the various stages—i.e. initiation, negotiation, closing and so forth—inherent in deploying this system. While potentially beneficial, mobile devices would not necessarily be required for this system to operate.

Receiving or making payment can occur through any number of systems. Direct cash payments between participants may be the most straight-forward mechanism. Payment or receipt of compensation to and from a third party is useful as it enables the deployment of the system without the need for participants to communicate directly. Those in a role that requires payment may make that payment to a third party. Those receiving compensation may then receive that payment from the third party. Further, one could setup accounts where money is established in an account and this money is used to fund roles in a platoon that require payment or to receive money for fulfilling roles that receive compensation. These accounts could, in the same way, also utilize a credit system. Those credits could remain isolated within that system or could be converted into currency or other forms.

This method is optimally managed through a system that consists of one or more processors and a memory communicably coupled to the one or more processors and storing various modules that perform functions within the method. The processors could be a microprocessor, microcontroller, digital signal processor (DSP), electronic control unit (ECU) or any other type of processing unit. The function of the memory is to store data or information that can be read. The memory could be volatile or non-volatile. It could be programmable, reprogrammable or read only. The memory could take any other form as long as it fills its function of storing data. The processor(s) and memory should be communicably linked. The modules will include instructions that can be executed by the processors. These modules could include an initiation module, an agreement module, a closing module, a logic module or any other module depending on the needed function designed to achieve the goals of the system.

In a preferred embodiment, the system for compensation would consist of one or more processors and a memory communicably coupled to the one or more processors and storing an initiation module, an agreement module, a logic module and a closing module. The initiation module would include instructions that when executed by the one or more processors cause the one or more processors to initiate a compensation mechanism where at least one willing participant communicates to potential participants of a potential platoon a willingness to accept a certain position or role within said potential platoon in exchange for a benefit to be received by said participant. The agreement module would contain instructions that when executed by the one or more processors cause the one or more processors to generate agreement on a compensation mechanism amongst at least the participants of the platoon where at least one participant of said platoon receives a benefit based on the role of the vehicle of said participant within said platoon. The logic module would contain instructions that when executed by the one or more processors cause the one or more processors to determine the optimum order of vehicles within the platoon and therefore order the vehicles within the platoon based on vehicle size, vehicle type or other characteristic of the vehicle in order to maximize the contribution to or benefit gained from participation of the collective sum of the vehicles within the platoon. Finally, the closing module would include instructions that when executed by the one or more processors cause the one or more processors to execute the transfer of compensation between participants in the platoon.

1. A platoon compensation system for providing compensation to at least one participating vehicle in a platoon comprising:
One or more processors; and
A memory communicably coupled to the one or more processors and storing:
An agreement module including instructions that when executed by the one or more processors cause the one or more processors to generate agreement on a compensation mechanism amongst at least the participants of the platoon where at least one participant of said platoon receives a benefit based on the role of the vehicle of said participant within said platoon.

2. The platoon compensation system of claim 1 further comprising
An initiation module including instructions that when executed by the one or more processors cause the one or more processors to initiate a compensation mechanism where at least one willing participant communicates to potential participants of a potential platoon a willingness to accept at least one of a certain position or role within said potential platoon in exchange for a compensation to be received or a payment to be made by said participant whether that compensation or payment involves members of the platoon, an independent entity or both.

3. The platoon compensation system of claim 1 further comprising
A closing module including instructions that when executed by the one or more processors cause the one or more processors to execute the transfer of compensation amongst participants in the platoon, including any payment to or from a separate entity.

4. The platoon compensation system of claim 1 further comprising
A logic module that determines the optimum order of vehicles within the platoon and a corresponding compensation schedule that determines compensation between participants based on that ordering logic.

5. The platoon compensation system of claim 4 further comprising
Ordering the vehicles within the platoon based on vehicle size, vehicle type or other characteristic of the vehicle in order to maximize the contribution to or benefit gained from participation of the collective sum of the vehicles within the platoon.

6. The platoon compensation system of claim 1 further comprising
Transacting on the compensation agreement where one or more participants receives financial payment in the intended currency based on their agreed role in the platoon.

7. The platoon compensation system of claim 6 further comprising
Transacting the compensation amounts in the agreement through a third party that acts in a role independent of the participants within the platoon.

8. The platoon compensation system of claim 1 further comprising
Transacting on the compensation agreement where one or more participants makes a financial payment in the intended currency based on their agreed role in the platoon.

9. The platoon compensation system of claim 8 further comprising
Transacting the compensation amounts in the agreement through a third party that acts in a role independent of the participants within the platoon.

10. The platoon compensation system of claim 1 further comprising
Compensation based on a credit system where one or more vehicles earns credits based on their agreed role in the platoon where these credits can be used in future transactions either in the same platoon or in a future platoon.

11. The platoon compensation system of claim 1 further comprising
Compensation based on a credit system where one or more vehicles pays credits into the system based on their agreed role in the platoon; these credits having either been earned as part of a previous platoon, purchased, gifted or otherwise obtained.

12. Platoon compensation system of claim 1 further comprising
At least one mobile device within each of a plurality of the vehicles where the mobile device contains at least one processor and a memory communicably coupled to the one or more processors of the mobile device and said memory storing a mobile communication module including instructions that when executed by the one or more of the processors of the mobile device cause the one or more processors to communicate the module instructions amongst at least one other member of the platoon or with a central server.

13. Platoon compensation system of claim 1 further comprising
A module including instructions that when executed by the one or more processors cause the compensation amount to be automatically determined based on conditions at the time of the platoon and established criteria relating to those conditions.

14. Platoon compensation system of claim 1 further comprising
A module including instructions that when executed by the one or more processors cause the compensation method to be determined through an offer, counter-offer mechanism where at least one participant suggests a compensation and at least one other participant either accepts the compensation or puts forth a competing compensation wherein any participant may put forth multiple offers and counteroffers until a compensation between participants is agreed.

15. The platoon compensation system of claim 1 further comprising
A plurality of participants within the platoon whose compensation or whose payment is based on the position of the vehicle within the platoon.

16. The platoon compensation system of claim 1 further comprising
A plurality of participants within the platoon whose compensation or whose payment is based on the type of vehicle, size of the vehicle or other characteristic of the vehicle that could reasonably impact the contribution to or benefit gained from participation of the vehicle within the platoon.

17. A method for compensating at least one participant in a platoon comprising
An agreement on a compensation mechanism amongst at least the members of the platoon where at least one participant of the platoon receives a benefit based on the role of the vehicle of said participant within said platoon.

18. The platoon compensation method of claim 17 further comprising
an act of initiation by at least one willing participant who communicates to potential members of a potential platoon a willingness to accept a certain position or role within said potential platoon in exchange for a benefit to be received or a payment to be made by said participant whether that compensation or payment involves members of the platoon, an independent entity or both.

19. The platoon compensation method of claim 17 further comprising
the transfer of compensation amongst participants of the platoon intended, through the agreement, to receive compensation or to make payment whether to or from members of the platoon or to or from a separate entity.

20. The platoon compensation method of claim 19 further comprising
Transacting on the compensation agreement where one or more participants receives financial payment in the intended currency based on their agreed role in the platoon.

21. The platoon compensation method of claim 19 further comprising
Transacting on the compensation agreement where one or more participants makes a financial payment in the intended currency based on their agreed role in the platoon.

22. The platoon compensation method of claim 17 further comprising
Compensation based on a credit system where one or more participants earns credits based on their agreed role in the platoon where these credits can be used in future transactions either in the same platoon or in a future platoon.

23. The platoon compensation method of claim 17 further comprising
Compensation based on a credit system where one or more vehicles pays credits into the system based on their agreed role in the platoon; these credits having either been earned as part of a previous platoon, purchased, gifted or otherwise obtained.

24. The platoon compensation method of claim 17 further comprising
Ordering the vehicles within the platoon based on vehicle size, vehicle type or other characteristic of the vehicle in order to maximize the contribution to or benefit gained from participation of the collective sum of the vehicles within the platoon.

25. The Platoon compensation method of claim 17 further comprising
At least one mobile device within each of a plurality of the vehicles where the mobile devices communicate the compensation instructions amongst at least one other member of the platoon or with a central server.

26. The Platoon compensation system of claim 17 further comprising
a compensation automatically determined through an algorithm based on conditions and established criteria relative to those conditions.

27. Platoon compensation system of claim 17 further comprising
an offer, counter offer mechanism where at least one participant suggests a compensation and at least one other participant either accepts the compensation or puts forth a competing compensation wherein any participant may put forth multiple offers and counteroffers until a compensation between participants is agreed.

28. The platoon compensation system of claim 17 further comprising
A plurality of participants within the platoon who are compensated based on their position in the platoon.

29. The platoon compensation system of claim 17 further comprising
A plurality of participants within the platoon whose compensation or whose payment is based on the type of vehicle, size of the vehicle or other characteristic of the vehicle that could reasonably impact the contribution to or benefit gained from participation of the vehicle within the platoon.

30. A method for compensating at least one participant in a platoon comprising
Ordering the vehicles within the platoon based on vehicle size, vehicle type or other characteristic of the vehicle in order to optimize the contribution to or benefit gained from participation of the collective sum of the vehicles within the platoon and establishing an optimal compensation strategy amongst at least the members of the platoon where the participants of the platoon receive benefit or make payment based on the role of said participant within said platoon.
